(19) United States
(12) Patent Application Publication
(10) Pub. No.: US 2005/0100175 A1
(43) Pub. Date: May 12, 2005

(54) Charger assembly having a loudspeaker

(76) Inventor: Bing Du, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/982,522

(22) Filed: Nov. 4, 2004

(30) Foreign Application Priority Data
Nov. 7, 2003 (TW) 92131177

(51) Int. Cl. H04B 1/00

(52) U.S. Cl. 381/86

(57) ABSTRACT

A charger assembly for a portable device includes a charger module for converting an outside source into a predetermined source for the portable device, a loudspeaker module comprising at least one filter for eliminating undesired signals form outside and inside of the charger assembly, an amplifier for amplifying the voice signals from said portable device to drive a speaker. The filter is a low-pass filter for eliminating the high frequency noise signals from the charger module.

### BACKGROUND OF THE INVENTION

1. Field of the Invention

The present invention relates to a charger assembly, and in particular to a charger assembly employed in a vehicle for a portable device.

2. Description of the Prior Art or Related Art

A portable device, such as a mobile phone or a personally digital assistant (PDA), usually has a rechargeable battery which needs a compatible charger. After a fully charging, standard standing time that the battery can provide usually is 1-7 days. But when a person is in a long-time travel by a car or other vehicle, a traditional charger is not available because the input is not compatible with the power supply of the vehicle. To get a more convenience application, a vehicle-type charger has been developed for portable application. However, either a traditional charger or a vehicle-type charger may introduce noise signal to a voice communication when the portable device is in charging. In this case, someone can use a wireless headset, such as a Bluetooth headset or an infrared headset to overcome such inconvenience. But since for a vehicle-type application, when someone is driving car and the portable device is in charging, a wireless headset will decrease his sensitive of the outside, which is danger to him. Also the noise from the charger is also exists, which will influence the quality of the voice.

U.S. Pat. No. 6,509,716 discloses a charger assembly comprising a first ear jack (220) which connects with a second ear jack (120) of a cellular phone. The second ear jack (120) transmits voice signals to a voice amplifier 240 which is used to amplify the voice signals to a desired level to drive a speaker. The speaker converts the voice signal to voice. However, such design doesn't overcome the above-mentioned disadvantage that the charger will introduce noise signals to the voice channel.

Hence, an improved charger assembly is desired to overcome the above-mentioned disadvantages of the prior and related arts.

### BRIEF SUMMARY OF THE INVENTION

A primary object of the present invention is to provide a charger assembly having a loudspeaker for a portable device.

A charger assembly for a portable device which comprising a voice input port coupling with the portable device, a charger module for converting an outside source into a predetermined source for the portable device, a loudspeaker module comprising at least one filter for eliminating undesired signals form outside and inside, an amplifier for amplifying the voice signals from said portable device to drive a speaker.

Another objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a block diagram illustrating a charger assembly of the present invention.

FIG. 2 illustrates a voice amplifying circuit of a loudspeaker module of the charger assembly.

### DETAILED DESCRIPTION OF THE INVENTION

Reference will now be made in detail to a preferred embodiment of the present invention.

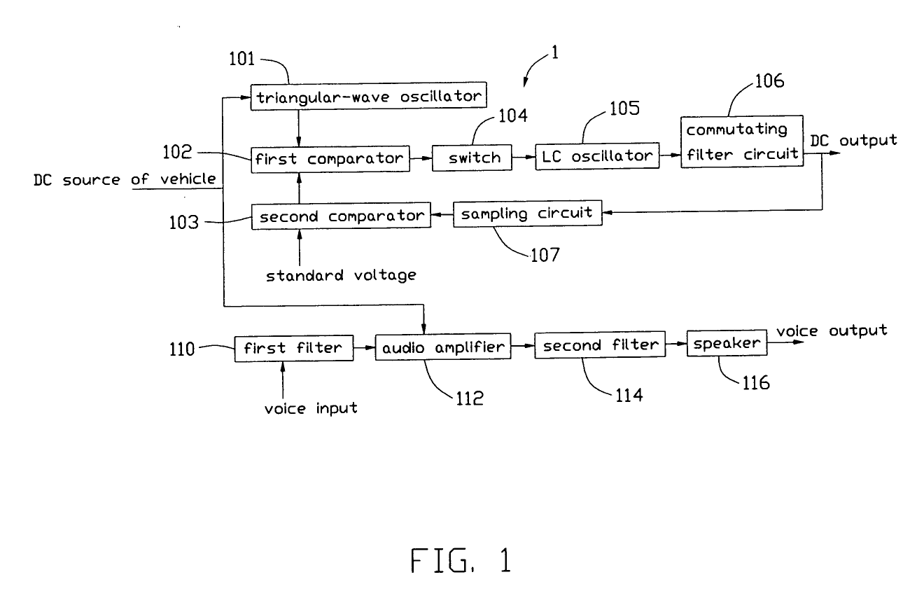

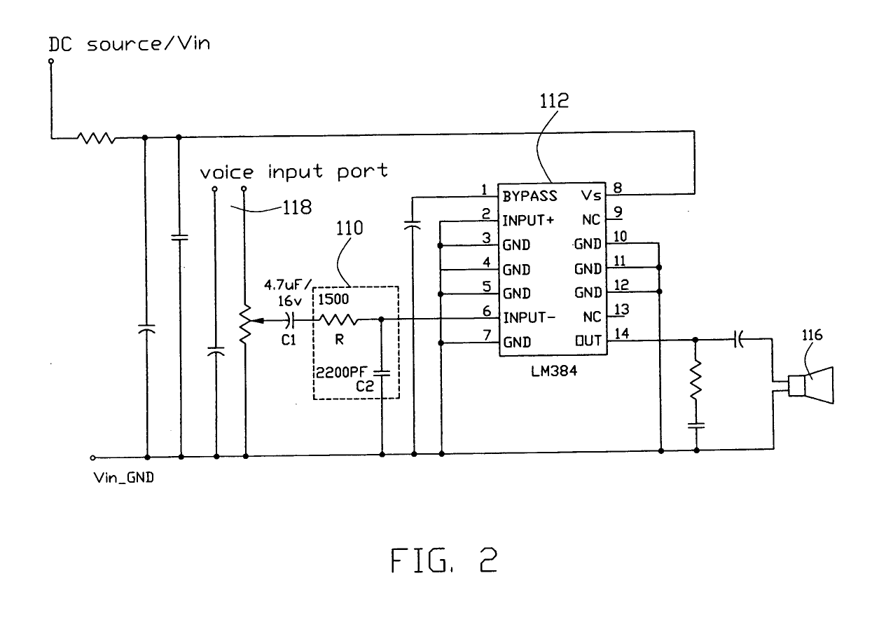

Referring to FIG. 1 and FIG. 2, a charger assembly 1 of the present invention using direct current (DC) power supply of a vehicle to charge a portable device (not shown) comprises charger module and a loudspeaker module.

The charger module is a DC-DC converter comprising a triangular-wave oscillator 101, a first and second comparators 102, 103, a switch circuit 104, a LC oscillator 105, a commutating filter circuit 106 and a sampling circuit 107. DC power supply of the vehicle is transformed to triangular-wave signals in said triangular-wave oscillator 101. Then the triangular-wave signals are input into a first comparator 102. An output of the second comparator 103 acts as another input of the first comparator 102. The result that the triangular-wave signals compare with the output of the second comparator 103 in the first comparator 102 acts as an output of the first comparator 102, which controls the state of the switch 104. When the output of first comparator 102 is a high voltage, the switch 104 is on and connects the first comparator 102 with LC oscillator 105, thus the peak value of a cosine signal oscillated in the LC oscillator 105 is increased. When the output of first comparator 102 is a low voltage, the switch is off and the first comparator 102 disconnects with LC oscillator 105, thus the peak value of the cosine signal oscillated in the LC oscillator 105 is decreased. The cosine signal is commutated and filtered by the commutating filter circuit 106 and then converted into a DC output for a battery of the portable device.

The DC output is sampled by the sampling circuit 107 and sent into the second comparator 103. The sampled DC output compares with a standard voltage (for instance, for most portable devices, the standard voltage is 5V) in the second comparator 103. Then the output of the second comparator 103 is sent into the first comparator 102. Thus a feedback is founded to adjust the DC output. When DC output is higher than the standard voltage, the second comparator 103 outputs a low voltage, which results the first comparator 102 outputs a low voltage and makes the peak value of the cosine signal decrease. Thus the DC output is reduced. When DC output is lower than the standard voltage, the second comparator 103 outputs a high voltage, which results the first comparator 102 outputs high voltage and makes the peak value of the cosine signal increase. Thus the DC output increases.

The loudspeaker module comprises a voice input port 118 for receiving voice signals from the portable device. The loudspeaker module further comprises a first filter 110 electrically coupling with said voice input port 118, an audio amplifier 112 connecting with the first filter 110, a second filter 114 coupling with the audio amplifier 112 and a speaker 116. The vehicle power supply source acts as DC power supply of the audio amplifier 112. The voice signals being transmitted from the portable device to the charger assembly 1 pass a first capacitance C1 and then are input into the first filter 112 that filters high frequency noise signals (such as more than 48 kHz). Said first capacitance C1 is used to separate the DC from the voice signals. Then the voice signals are sent into the audio amplifier 112 which amplifies the voice signals to a desired level for driving the speaker 116. The speaker 116 transforms the voice signals into voice. The audio amplifier 112 can be a general amplifier, such as an integrated circuit chip named LM384 (manufactured by National Semiconductor of Santa Clara). The second filter 114 coupling between the audio amplifier 112 and the speaker 116 is a high-pass filter for eliminating high frequency noise signals. Said second filter 114 is formed by the input impendence of the audio amplifier 112 and the first capacitance C1 (4.7 uF).

The first filter 10 formed by a resistor R and a second capacitance C₂ is a low-pass filter which is used to eliminate the higher frequency noise signals that are mostly from Triangular-wave oscillator 101 and the LC oscillator 105, which can be coupled into the loudspeaker module via some capacitive components.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A charger assembly for a portable device used in a vehicle comprising:
a charger module for converting a power source of the vehicle into a predetermined direct current (DC) supply;
a loudspeaker module comprising a first filter for eliminating undesired signals from both outside and inside of the charger assembly, an amplifier electrically coupled with the first filter for amplifying voice signals from said portable device into a desired level and a speaker transforming said voice signals to voice.

2. The charger assembly as claimed in claim 1, wherein the first filter is a low-pass filter for filtering high frequency noise signals which are from outside and inside of the charger assembly.

3. The charger assembly as claimed in claim 1, further comprising a second filter which is a high-pass filter for eliminating low frequency noise signals which are from outside and inside of the charge assembly.

4. The charger assembly as claimed in claim 3, wherein the second filter is formed by the input impedance of the amplifier and a capacitance.

5. A charger assembly for a portable device used in a vehicle comprising:
a charger module for converting a power source of the vehicle into a predetermined direct current (DC) supply;
a loudspeaker module comprising:
a first filter for eliminating undesired high frequency signals from the charge module,
a second filter for eliminating undesired lower frequency signals from a circumstance;
an amplifier connected between said first filter and said second filter.
